(19) United States
(12) Patent Application Publication
(10) Pub. No.: US 2007/0242667 A1
(43) Pub. Date: Oct. 18, 2007

(54) SYSTEM AND METHOD FOR CHOOSING AN OUTGOING PATH FOR A MEDIA FLOW IN A NEXT GENERATION NETWORK

(75) Inventor: Enhui LIU, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/753,107

(22) Filed: May 24, 2007

Related U.S. Application Data
(63) Continuation of application No. PCT/CN06/01140, filed on May 29, 2006.

(30) Foreign Application Priority Data
Jul. 30, 2005 (CN) 200510088339.2

(51) Int. Cl. H04L 12/56

(52) U.S. Cl. 370/389

(57) ABSTRACT

A system and a method for choosing an outgoing path for a media flow in a Next Generation Network (NGN) are disclosed. First, an application layer signalling resolving module in a Service Control Function (SCF) resolves an application layer signalling to determine requirement of a media flow on forwarding and provides determined requirement to a Policy Decision Function (PDF); then, the PDF determines identification (ID) of an outgoing path for the media flow according to requirement of the media flow on forwarding and a policy stored by itself, and provides determined ID to a traffic forwarding control module in a Border Gateway Function (BGF); finally, the traffic forwarding control module in the BGF controls the forwarding of the media flow, and steering the media flow to the outgoing path according to the ID of the

This application is a continuation of International Patent Application No. PCT/CN2006/001140, filed May 29, 2006, which claims priority to Chinese Patent Application No. 200510088339.2, filed Jul. 30, 2005, all of which are hereby incorporated by reference.

### FIELD OF THE TECHNOLOGY

The present invention relates to network communication technologies, and particularly, to a system and a method for choosing an outgoing path for a media flow in a Next Generation Network (NGN).

### BACKGROUND OF THE INVENTION

In an NGN network, a service layer is separated from a transport layer. The transport layer is based on packet technologies and optical technologies while the service layer may provide many kinds of multimedia services. Security and Quality of Service (QoS) of a service in an NGN network are the main problems in developing the network services since an NGN network is based on Internet Protocol (IP) packet technologies. In an NGN network, there are many factors affecting network security and QoS. For example, different transport technologies and different transport paths will undoubtedly affect the network security and the QoS.

An operator generally possesses new networks and old networks at the same time in the process of network evolvement and convergence, and thus, there may be multiple transit networks operating at the same time which are physically separated from each other, such as an Asynchronous Transfer Mode (ATM) network, an Internet Protocol Version 4 (IPv4) network, a Multi-protocol Label Switching (MPLS) network and an Internet Protocol Version 6 (IPv6) network, in the core network. The QoS and security guarantee ability of these transit networks are different due to their different transport technologies.

Therefore, various Virtual Private Networks (VPNs), Virtual Local Area Networks (VLANs), MPLS Label Switching Paths (MPLS LSPs) and other tunnel technologies need to be used at the border of a network to aggregate and separate traffics of various types in the core network, so as to improve the QoS of the network and achieve security guarantee.

An edge node of an access network's operator may be connected with multiple core networks of different operators so as to make a subscriber freely choose different core network operators.

So, a requirement on choosing a core network and a path in the core network for a media flow at the border of a network is common. Choosing a core network as well as choosing a path in the core network are to choose an outgoing physical link, a virtual link or a VPN for a media flow. At present, aggregation and path steering of traffics in a core network are generally performed by statically configuring a policy route in a Border Gateway Function (BGF) which may be a Broadband Remote Access Server (BRAS), an Edge Router, a Provider Edge and a Border Router, etc.

However, the static configuration method can support only coarse granularity aggregation and path steering of traffics and cannot support service priority processing, QoS processing or security hierarchy processing based on subscriber level and session level of services in an NGN network.

At present, there is also a method in which a bandwidth manager or a path calculating element is used to calculate in real time an edge-to-edge LSP for traffics in an MPLS network. In this method, the calculation is performed mainly according to the QoS requirement of traffics, availability condition as well as usage condition of internal resources in the network, so as to avoid decrease in QoS of the network due to congestion and competition.

The method is limited to an edge-to-edge path choosing in an MPLS network. However, transport technologies at an edge egress of a network and transport technologies of an interconnecting link between domains are diverse.

Therefore, the method above is not applicable in the case that other technologies (such as a physical link separation, various VPNs and VLANs, and various tunnel technologies) are used to perform aggregation and path steering of traffics at an edge egress of a network, and is also not applicable to choose an interconnecting link between different network domains.

### SUMMARY OF THE INVENTION

A system and a method for choosing an outgoing path for a media flow in a Next Generation Network (NGN) are provided.

Embodiments of the present invention provide a system for choosing an outgoing path for a media flow in an NGN network, including:

an application layer signalling resolving module set in a Service Control Function (SCF), for determining requirement of a media flow on forwarding by resolving an application layer signalling;

a Policy Decision Function (PDF), for determining an Identification (ID) of the outgoing path for the media flow according to the requirement of the media flow on forwarding provided by the application layer signalling resolving module, and a policy stored by the PDF;

a traffic forwarding control module set in a Border Gateway Function (BGF), for controlling forwarding of the media flow according to the ID of the outgoing path provided by the PDF, and steering the media traffic to the outgoing path.

Embodiments of the present invention also provide a method for choosing an outgoing path for a media flow in a Next Generation Network (NGN) network, including:

determining requirement of a media flow on forwarding by resolving an application layer signalling;

determining an Identification (ID) of the outgoing path for the media flow according to the requirement of the media flow on forwarding as well as a policy;

controlling forwarding of the media flow according to the ID of the outgoing path, and steering the media flow to the outgoing path.

As can be seen from the above technical solutions provided by embodiments of the present invention, control is performed at an edge egress of a network and at an interconnecting link between domains. If a media flow enters an MPLS network forward, the path choosing method in the prior art will be adopted inside the entered MPLS network. Thus, an end-to-end cross-domain path choosing can be implemented.

In embodiments of the present invention, fine granularity choosing of a core network and choosing of a path in the core network based on subscriber level and session level of a service in an NGN network can be implemented through cooperation between an SCF and a BGF in the transport layer, so as to improve the QoS and the security guarantee ability of the NGN.

### BRIEF DESCRIPTION OF THE DRAWINGS

FIG. 1 shows a schematic diagram illustrating an exemplary structure of a system in accordance with an embodiment of the present invention.

FIG. 2 shows a schematic diagram illustrating an exemplary flow chart of a method in accordance with an embodiment of the present invention.

### EMBODIMENTS OF THE INVENTION

In order to make the objective, technical solutions and advantages of embodiments of the present invention clearer, a detailed description of the present invention is hereinafter given with reference to the drawings and detailed embodiments.

Embodiments of the present invention provide a system and a method for choosing an outgoing path for a media flow in an NGN network, and specifically, provide a system and a method for choosing a core network and a path in the core network for a media flow, which can implement a fine granularity choosing of a core network and a fine granularity choosing of a path in the core network based on subscriber level and session level of a service in the NGN. And the two kinds of choosing above can be implemented through cooperation between a Service Control Function (SCF) and a BGF in the transport layer, so as to improve the QoS and the security guarantee ability of the NGN.

The system and method provided by embodiments of the present invention can be combined well with the choosing method of an internal path in an MPLS network in the prior art, and the path choosing method provided by embodiments of the present invention is used to perform the control at an edge egress of a network and at an interconnecting link between domains. If a media flow enters an MPLS network forward, the internal choosing method in the MPLS network will be adopted to perform control inside the entered MPLS network. Thus, an end-to-end cross-domain path choosing can be implemented.

Embodiments of the present invention provide a system and a method for choosing a core network and a path in the core network for a media flow, which can implement a fine granularity choosing of a core network and a fine granularity choosing of a path in the core network based on subscriber level and session level of a service in the NGN. And the two kinds of choosing above can be implemented through cooperation between an SCF and a BGF in the transport layer, so as to improve the QoS and the security guarantee ability of the NGN.

Embodiments of the present invention provide a system and a method for choosing a core network and a path in the core network for a media flow, which chooses a core network and a path in the core network for a media flow based on a policy according to information of priority, QoS, and requirement on security level of a subscriber's session, so as to control the traffic forwarding of the BGF.

The system and method provided by embodiments of the present invention may be integrated into a resource and admittance control framework in the NGN as a synthetic solution to a QoS control, a Network Address & Port Translation (NAPT) traversal and a firewall control in the NGN, or may also be applied in the NGN independently.

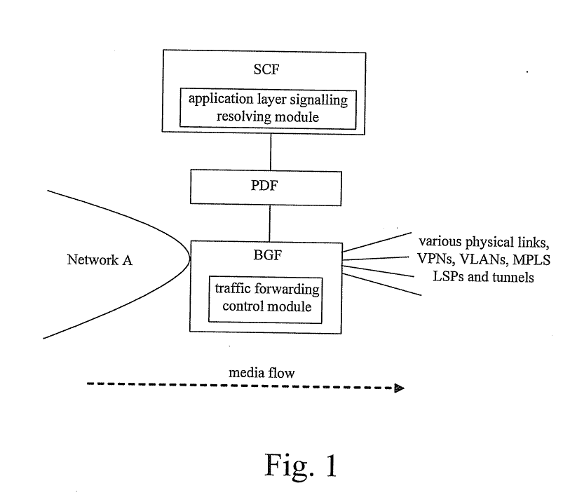

FIG. 1 shows a schematic diagram illustrating an exemplary structure of a system in accordance with an embodiment of the present invention. As shown in FIG. 1, a system for choosing a core network and a path in the core network for a media flow in an NGN network may specifically include the following modules.

(1) an application layer signalling resolving module is set in an SCF. The application layer signalling resolving module is used for resolving an application layer signalling of a service, so as to determine requirement of a media flow on forwarding and provide the determined requirement to a Policy Decision Function (PDF).

The SCF is a service control proxy in general, and specifically, may be a Proxy Call Session Control Function (P-CSCF) in an IP Multimedia Subsystem (IMS) in the NGN, or a Call Agent device in a Softswitch system in the NGN.

(2) The PDF is used for determining ID of an outgoing path for a media flow, according to the requirement of the media flow on forwarding and policy stored by itself. The PDF also provides the determined ID to a traffic forwarding control module. The PDF may be an independent device, or a functional module integrated into the SCF or a BGF.

(3) The traffic forwarding control module is used for controlling the forwarding of the media flow according to the ID of the outgoing path.

In other words, the traffic forwarding control module is located in a BGF, which may be a BRAS, an Edge Router, a Provider Edge or a Border Router, in the path of the media flow, and is used for choosing an outgoing path for the media flow.

Preferably, the system further includes a resource and admittance control function used for acquiring the requirement of the media flow on forwarding and the ID of the outgoing path determined by the PDF, performing a corresponding resource admittance control processing. And when the resource admittance control is passed, the PDF provides the ID of the outgoing path to the traffic forwarding control module.

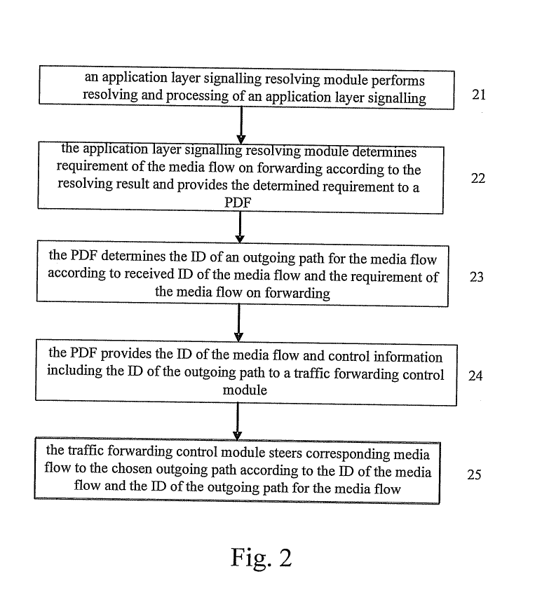

Based on the system shown in FIG. 1, the specific implementation of a method for choosing a core network and a path in the core network for a media flow in an NON network is shown in FIG. 2. And the method specifically includes the following processes.

In block 21: an application layer signalling resolving module in an SCF performs resolving and processing of an application layer signalling.

Embodiments of the present invention do not specifically define contents of the information acquired from the resolving because different applications use different application protocols, such as a Session Initiation Protocol (SIP) a Session Description Protocol (SDP), an H.323 etc, and information resolved from different protocols is different from each other.

In block 22: the application layer signalling resolving module in the SCF detenmines requirement of a media flow on forwarding, and provides the determined requirement to a PDF. This process specifically includes: the application layer signalling resolving module in the SCF provides the ID of the media flow, together with the requirement of the media flow on forwarding, such as a requirement on QoS, a requirement on service priority and a requirement on security level, to the PDF.

Specifically, the application layer signalling resolving module in the SCF determines requirement of the media flow on forwarding according to the application type, the subscriber attribute and the information of the media flow in the application layer signalling.

In block 23: the PDF determines ID of an outgoing path for the media flow based on information of a policy stored by itself, according to the received ID of the media flow and the requirement of the media flow on forwarding.

The information of the policy can be established flexibly by the operator according to layout and deployment of a network and thus, will not be described herein.

The ID of the outgoing path may be: a physical link identified with a number of a device port, a VPN Routing Forwarding instance (VRF) in a VPN, a VLAN ID, an MPLS LSP LABEL, or IDs of tunnels of various encapsulation types.

In block 24: the PDF provides the ID of the media flow and control information including the ID of the outgoing path to a traffic forwarding control module in a BGF, so as to control the traffic forwarding of the BGF.

In block 25: the traffic forwarding control module in the BGF performs the traffic forwarding according to the received ID of the media flow and ID of the outgoing path, and steers the media flow to the chosen outgoing path.

In block 23, in the case that there is a Resource and Admittance Control Function (RACF) in a forward network with which the outgoing path is connected, the PDF may also provide the received ID of the media flow, the requirement on forwarding and the determined ID of the outgoing path together to the RACF in the forward network to perform a resource admittance control in the network under the administration of the RACF. Blocks 24 and 25 will not be performed if the resource admittance control in the forward network is not passed. And blocks 24 and 25 will be performed when the resource admittance control is passed.

To sum up, in embodiments of the present invention, a fine granularity choosing of a core network and a fine granularity choosing of a path in the core network based on subscriber level and session level of a service in the NGN can be implemented. And the two kinds of choosing can be implemented through cooperation between an SCF and a BGF in the transport layer, so as to improve the QoS and the security guarantee ability of the NGN.

The foregoing descriptions are only preferred embodiments of the present invention. The protection scope of the present invention, however, is not limited to the above descriptions. Any change or substitution, within the technical scope disclosed by embodiments of the present invention, easily occurring to those skilled in the art should be covered by the protection scope of the present invention. Therefore, the protection scope of the present invention should be according to the claims.

What is claimed is:

1. A system for choosing an outgoing path for a media flow in a Next Generation Network (NGN) network, comprising:
an application layer signalling resolving module set in a Service Control Function (SCF), for determining requirement of a media flow on forwarding by resolving an application layer signalling;
a Policy Decision Function (PDF), for determining an Identification (ID) of the outgoing path for the media flow according to the requirement of the media flow on forwarding provided by the application layer signalling resolving module, and a policy stored by the PDF;
a traffic forwarding control module set in a Border Gateway Function (BGF), for controlling forwarding of the media flow according to the ID of the outgoing path provided by the PDF, and steering the media traffic to the outgoing path.

2. The system of claim 1, further comprising:
a Resource and Admittance Control Function (RACF), for acquiring the requirement of the media flow on forwarding and the ID of the outgoing path, performing a resource admittance control processing; and
if the resource admittance control is passed, the PDF providing the ID of the outgoing path to the traffic forwarding control module.

3. The system of claim 1, wherein the SCF comprises:
a Proxy Call Session Control Function (P-CSCF) in an Internet Protocol Multimedia Subsystem (IMS) in the NGN network, or a Call Agent device in a Softswitch system in the NGN network, or an SCF having a proxy function in other service systems in the NGN network.

4. The system of claim 1, wherein the PDF is set in the SCF or the BGF, or is set to be an independent device.

5. A method for choosing an outgoing path for a media flow in a Next Generation Network (NGN) network, comprising:
determining requirement of a media flow on forwarding by resolving an application layer signalling;
determining an Identification (ID) of the outgoing path for the media flow according to the requirement of the media flow on forwarding as well as a policy;
controlling forwarding of the media flow according to the ID of the outgoing path, and steering the media flow to the outgoing path.

6. The method of claim 5, wherein the requirement of the media flow on forwarding comprises:
the ID of the media flow and requirement of Quality of Service (QoS) and priority.

7. The method of claim 5, after determining the ID of the outgoing path for the media flow, the method further comprising:
performing a resource admittance control processing.

8. The method of claim 5, wherein the ID of the outgoing path comprises:
a physical link identified with a number of a device port, or a Virtual Private Network Routing Forwarding instance (VRF) in a Virtual Private Network (VPN), or a Virtual Local Area Network ID (VLAN ID), a Label of a Label Switching Path of a Multi-protocol Label Switching (MPLS LSP Label), or IDs of tunnels of various encapsulation types.
